(19) United States
(12) Patent Application Publication
(10) Pub. No.: US 2004/0120056 A1
(43) Pub. Date: Jun. 24, 2004

(54) Exterior blind spot-overtaking non-distortion mirrors

(76) Inventor: Roger J. Goolsby, Rex, GA (US)

Correspondence Address: Rojego Corporation, 211 Orchard Road, Rex, GA, 30273-1421, US

(21) Appl. No.: 10/327,819

(22) Filed: Dec. 24, 2002

(51) Int. Cl. G02B 5/08

(52) U.S. Cl. 359/866

(57) ABSTRACT

A driver side and passenger side exterior rearview mirror system for After Market or new vehicles to provide an adequate display of vehicles in the regular view area, the overtaking area, and the blind spot area in one single contiguous mirror. This is all done with three flat plane mirror sections with different degree planes connected with multiple narrow strip flat plane transition sections with degree changes of ½ to 1 degree each to avoid noticeable view gaps and distortion, similar to rapid still pictures in movies causing still objects to appear to be moving. This produces a large mirror display area and positioned so that the driver instantly understands the situation in the entire area behind his frontal view including the blind spot area along with overtaking vehicles and the regular viewing area. The driver can then make instant accurate judgmental decisions about making a lane change or moving into a lane, thus avoiding the danger caused by overlooking the vehicles in the danger area which did not show up in prior exterior rearview mirrors or showed up in a distorted misleading or confusing manner.

### CROSS REFERENCE TO RELATED APPLICATIONS

U.S. Pat. No. 6,270,225

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to the blind spot and overtaking vehicles entering the blind spot area on each side of a vehicle in which the driver can not see vehicles in the blind spot area or vehicles about to enter the blind spot area in a single flat plane sideview mirror, thus causing some vehicle accidents and “Road Rage” incidents for which our invention solves the problem while other inventors have tried but all have failed. The convex passenger side exterior rearview mirror currently required on new cars increases the danger problem because it makes overtaking and blind spot vehicles incorrectly appear to be 100 feet or more behind the driver which worsens the danger then causes even more accidents plus created the term “Road Rage”.

This invention specifically eliminates the dangerous distortion caused by the passenger side exterior rearview convex mirror currently required by the U.S. Department of Transportation. The current passenger side exterior rearview convex mirror is a major cause of accidents, near accidents, and “Road Rage” incidents when many people switch to the right hand lane thinking the vehicle in the passenger side exterior rearview mirror is far behind when in fact it is in the blind spot or overtaking area. Thus “cutting off” the driver in the “blind spot”, or overtaking area, which then provokes a hot tempered idiot “blind spot” driver into a “road rage” incident and sometimes shooting at the other driver. This invention also eliminates the driver side lane-changing hazard caused by the current driver side single flat plane driver side exterior rearview mirror by displaying vehicles without distortion in all three danger areas.

Distortion would be caused by prior exterior rearview mirror inventions using convex or concave mirrors, rounded angles, wide dividers between viewing flat planes, viewing area too small, inadequate angles, no provision for overtaking vehicle danger, or located on or about the regular flat plane mirror in a confusing manner. All previous inventions would require mental interpretation to provide necessary information to the driver which in turn would worsen the blind spot and overtaking problem and would then become a hazard while attempting to provide a safety device.

Some additional prior art that has failed to provide a viable solution to the blind spot and overtaking problem with convex and concave mirrors, U.S. Pat. No. are:

U.S. Pat. Nos. 3,337,285: 3,389,952; 4,306,770; 4,331,382; EP-435-792-A; U.S. Pat. Nos. 5,793,542; 6,076,934; 6,398377

All of the above produce distortion and misleading information to the driver which in turn is more dangerous than a single flat plane sideview mirror.

Some prior art that has failed to provide a viable solution to the blind spot and overtaking problem with flat plane sideview mirror sections, U.S. patent numbers are:

U.S. Pat. Nos. 2,279,751; 3,628,851; 3,826,563; 3,797,920; 4,182,552; 4,859,046; 6,007,207; 6,390,632; 6,439,729; 6,450,653

None of the above flat plane mirrors provide a viable solution to the blind spot due to wide dividers, peculiar positions, etc. None of them even attempts to provide a solution to the overtaking problem and generally all of them appear to ignore the passenger side exterior rearview mirror problem. The passenger side exterior rearview mirror requires a different design from the driver side exterior rearview mirror due to the extra distance from the driver to the said mirror.

A patent search was made for a mirror base with any similarities to this subject invention mirror substrate base but none were found.

Inside mirrors with different angles, convex, concave, or flat plane sections can not provide the solution to the blind spot or overtaking problem because, aside from other deficiencies, passengers and post supporting the vehicle roof obstruct the driver's view through the interior rearview mirror and would increase the danger if a driver depends on them for lane changing decisions.

This inventor examined more than 70 U.S. patents regarding vehicle mirrors and none of them, except U.S. Pat. No. 6,270,225 patented by this inventor, provide a viable solution to the blind spot and overtaking vehicle danger problem.

### BRIEF SUMMARY OF THIS INVENTION

The object of this invention is to display the regular view of vehicles behind the driver's vehicle along with the display of vehicles in the adjacent lanes on both sides in the blind spot area and overtaking vehicles to the rear of and adjacent to the blind spot area while entering the blind spot area. This is done with a driver side exterior rearview mirror and a passenger side exterior rearview mirror using an adequate viewing image positioned for relativity, and without distortion using three wide flat plane mirror surfaces at appropriate angles for each of the three sections. Each wide mirror section is connected using narrow flat plane transition mirrors with flat plane angle changes of ½ to 1 degree to eliminate noticeable view gaps and prevent distortion. This transition system is similar to the rapid “still pictures” in movies that causes still objects to appear to be moving in which the naked eye does not notice the gap between the rapid still pictures.

This invention is directed toward three viewing areas of flat plane mirrors of adequate size at appropriate angles without any distorted portions in a relative position so that a driver does not have to interpret what he sees in the mirror viewing areas. The view of this sideview mirror invention will be very clear, without any need for interpretation or special thought process, which will render the correct decision much faster and much safer.

As detailed in the drawings for the driver side exterior rearview mirrors and passenger side exterior rearview mirrors, the nearest section, A and D, has an image of vehicles hundreds of feet to the rear of the driver. The second section, B and E, with an optional slight reddish tint, has an image of vacant paving or roadside or whatever is in the area just behind the blind spot area, or a vehicle entering the blind spot area if a vehicle is overtaking the driver. The third section, C and F, with an optional slight reddish tint, will be showing the rapidly passing landscape alongside the road unless there is a vehicle in the blind spot area, then at such time will show a vehicle in the blind spot. The same type view occurs on both sides of the driver's vehicle for a lane on either side.

The proper need and use of this invention would be, at such time as a driver may wish to change lanes on a multi-lane road, to instantly notify the driver at a glance that a vehicle is in the area to the rear of and adjacent to the blind spot area or is either entering the blind spot as an overtaking vehicle, or that a vehicle is maintaining the same speed as the driver and positioned in the blind spot. This invention would save many lives if provided on all vehicles.

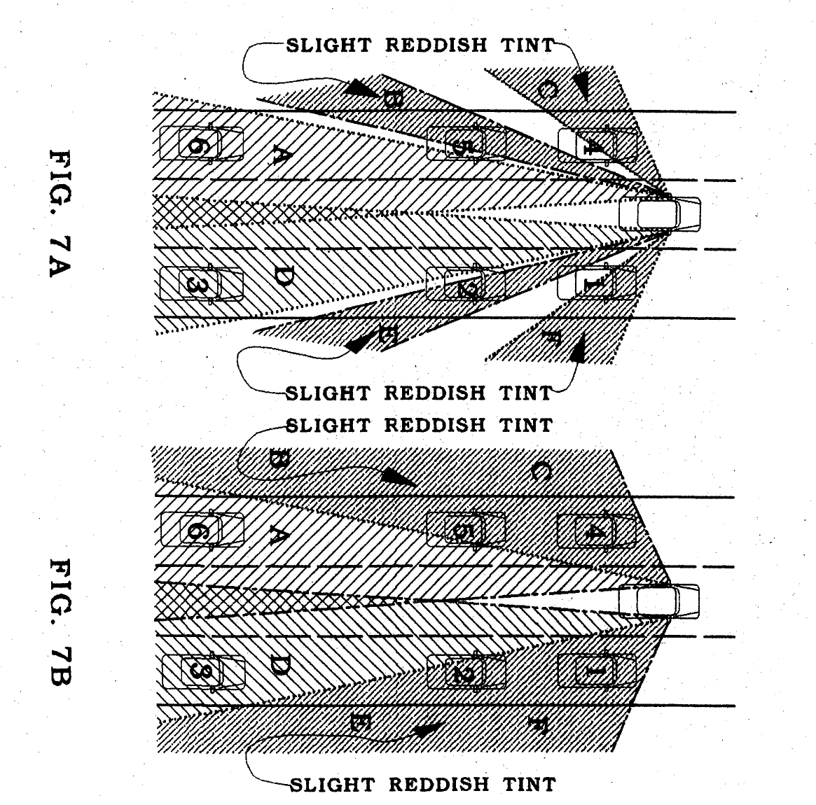

It is also noted that none of the researched prior inventions are being included on new vehicles, except the dangerous accident causing passenger side exterior rearview convex distortion mirror, currently and mistakenly required by the U.S. Department of Transportation. The current convex mirror causes Car 1 in FIGS. 7A and 7B to appear almost as far back as Car 3, which causes many accidents

### BRIEF DESCRIPTION OF THE SEVERAL VIEWS OF THE INVENTION

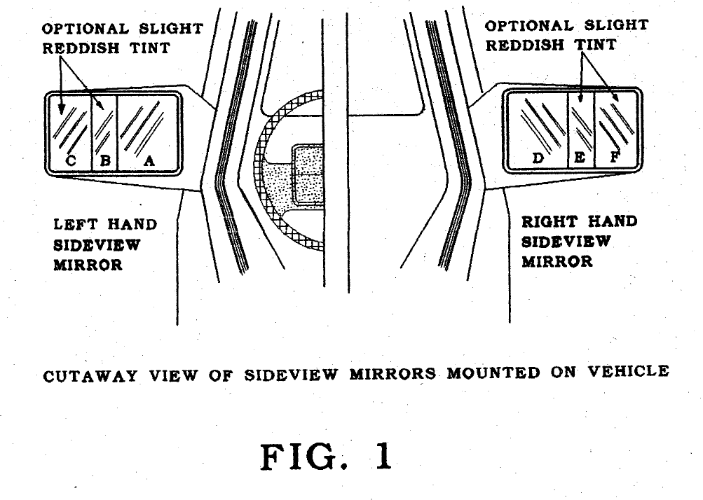

FIG. 1 is a cutaway view of both of the exterior rearview mirrors mounted on a vehicle which shows how they would appear after installation. The letters identifying each section will not be present on the finished product.

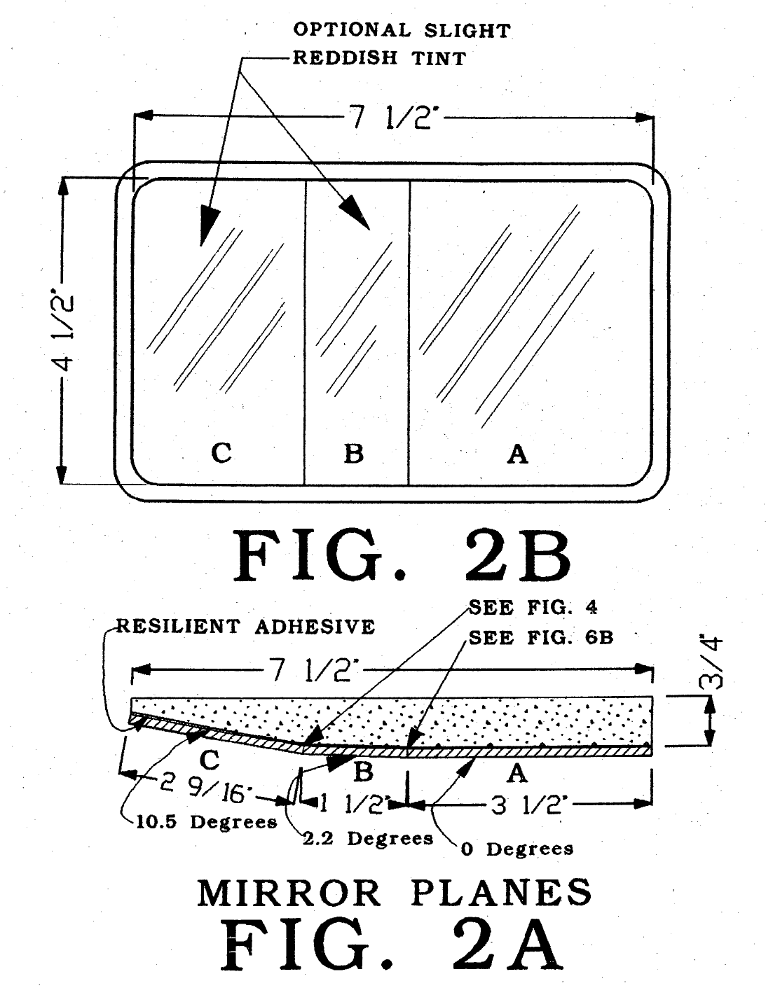

FIG. 2A is a view of the cutaway section of the driver side exterior rearview mirror which shows the angle and approximate width of each of the three sections of the mirror.

FIG. 2B is a view of the elevation of the driver side exterior rearview mirror which shows the position of the three sections of the mirror, along with the optional reddish tint, in Sections B and C.

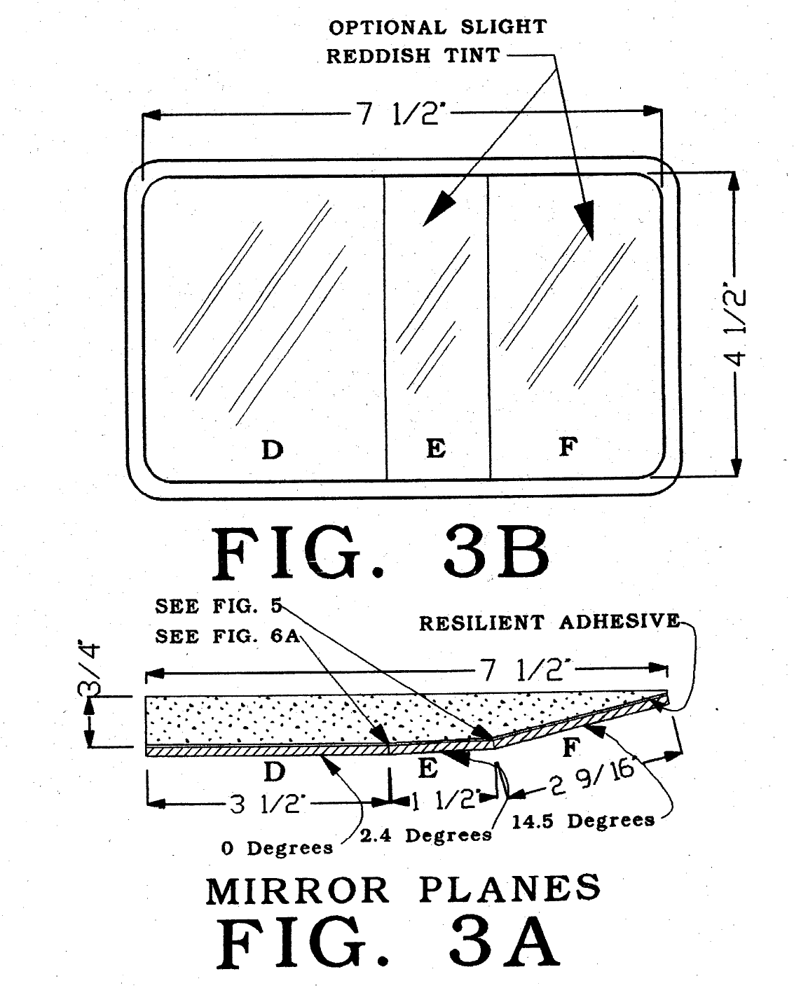

FIG. 3A is a view of the cutaway section of the passenger side exterior rearview mirror, which shows the angle and approximate width of each of the three sections of the mirror.

FIG. 3B is a view of the elevation of the passenger side exterior rearview mirror which shows the position of the three sections of the mirror, along with the optional reddish tint glass, in Sections E and F.

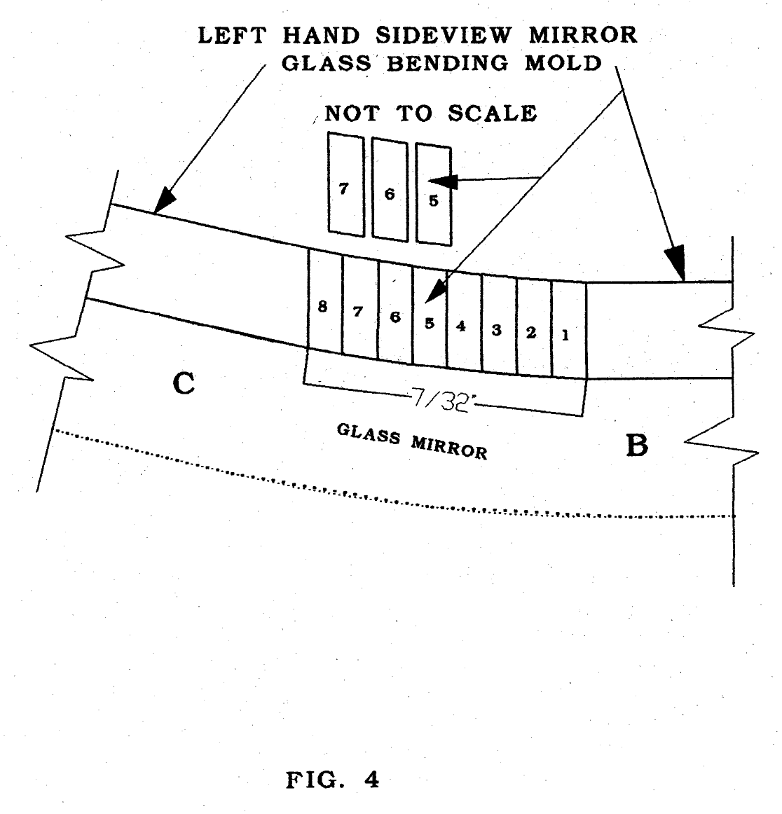

NOTE: Each transition plate detailed in FIGS. 4, 5, 6A, and 6B, 10, 11, 12A and 12B, will be precision ground to exactly the degree needed to avoid noticeable view gaps, which should range from 1 degree down to ½ degree. The number of flat narrow plates will vary according to the degree or fractions thereof as needed to avoid noticeable view gaps

FIG. 4, for the driver side exterior rearview mirror, is a detail of the transition bending plates that will be used in the glass mold to produce the narrow flat plane bending planes transition from mirror plane B to mirror plane C. The total transition is from approximately 2.2 degrees to 10.5 degrees for the driver side exterior rearview mirror. The span of the transition plates should remain approximately 7/32″.

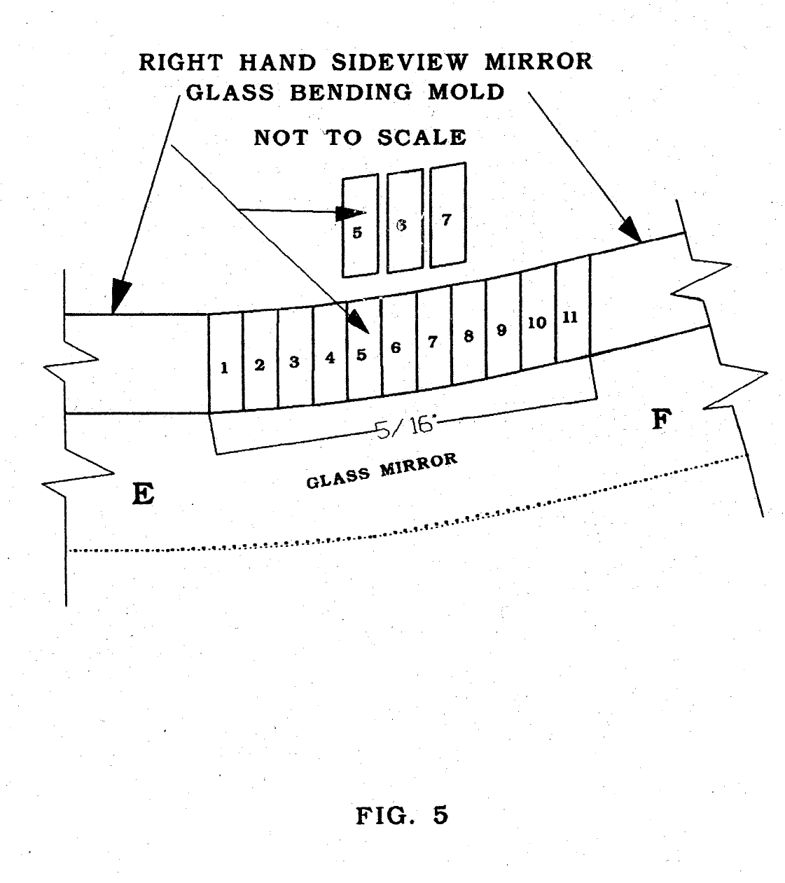

FIG. 5, for the passenger side exterior rearview mirror, is a detail of the transition bending plates that will be used in the glass mold to produce the narrow flat plane bending planes transition from mirror plane E to mirror plane F. The total transition is from approximately 2.4 degrees to 14.5 degrees for the passenger side exterior rearview mirror. The span of the transition plates should remain approximately 5/16″.

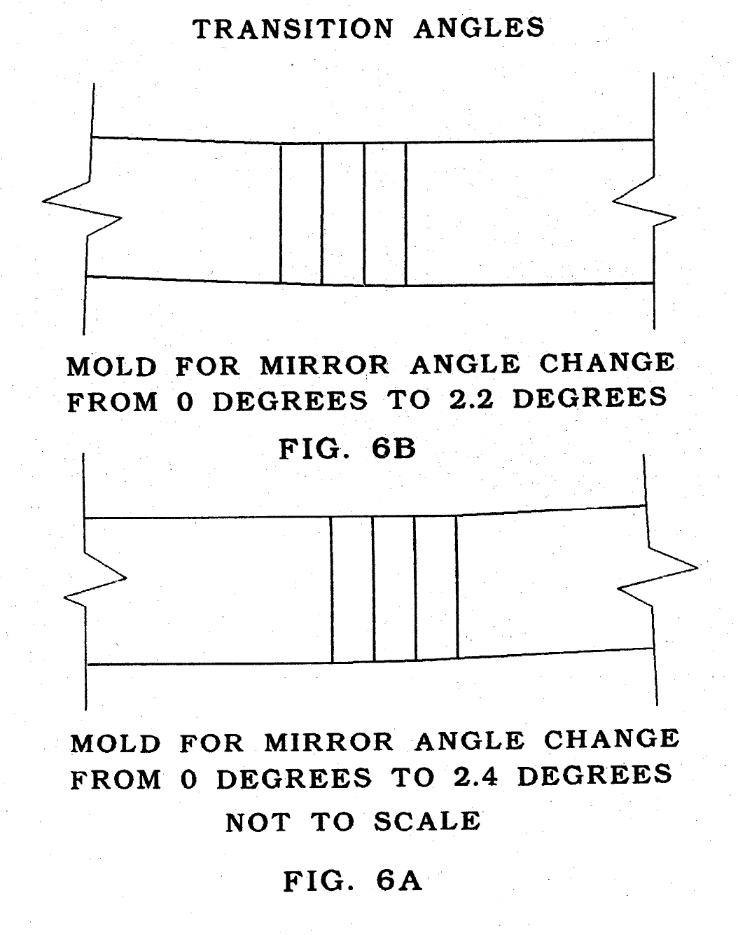

FIG. 6B, for the driver side exterior rearview mirror, is a detail of the transition strip bending plates that will be used in the glass mold to produce the narrow flat plane transition from mirror plane A to mirror plane B. The total transition is from 0 degrees to approximately 2.2 degrees for the driver side exterior rearview mirror. The span of the transition plates should remain approximately 3.75/32″.

FIG. 6A, for the passenger side exterior rearview mirror, is a detail of the transition bending plates that will be used in the glass mold to produce the narrow flat plane transition from mirror plane D to mirror plane E. The total transition is from 0 degrees to approximately 2.4 degrees for the passenger side exterior rearview mirror. The span of the transition plates should remain approximately ⅛″.

FIG. 7A, is the view area for the mirrors on each side of a vehicle, without the narrow flat plane transition mirror sections, which shows the approximate viewing area of each large section of the exterior rearview mirrors, the actual viewing area would vary depending on the closeness and the position of the driver's head while driving or while viewing the mirrors, also shows the location of the mirrors on the vehicle from front to rear which is the standard location for exterior rearview mirrors.

FIG. 7B, is the view area displayed using this transition bending method invention. There will not be any distortion and the view gaps will be so tiny they will not be noticeable to the naked eye similar to viewing movie pictures.

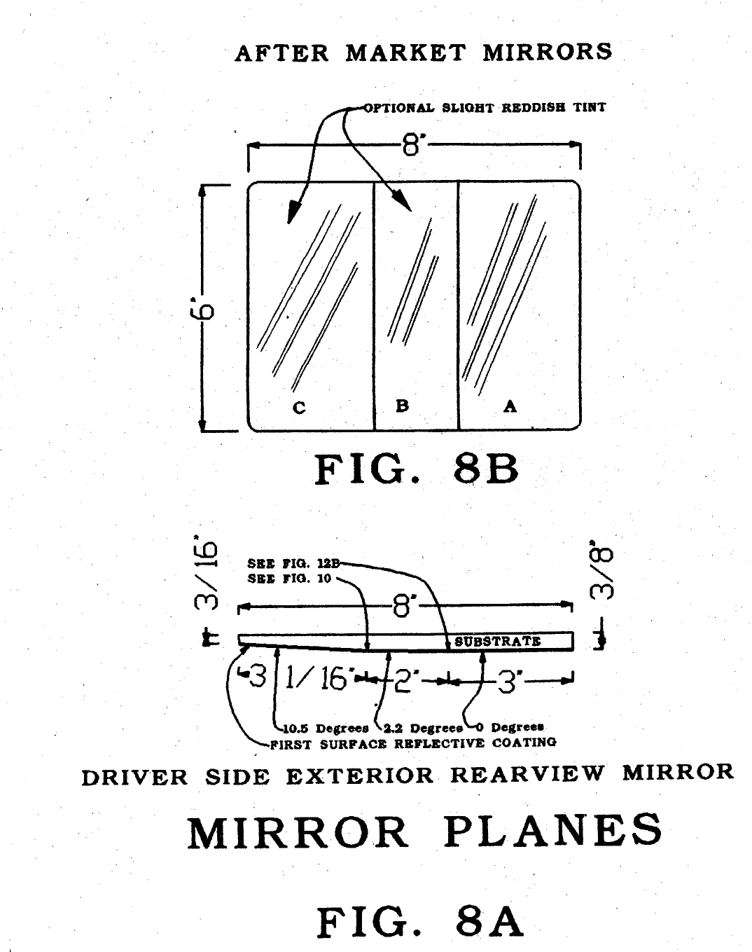

FIG. 8A, a view of the cutaway section of the driver side exterior rearview mirror which shows the angle and approximate width of each of the three sections of the mirror with the larger size for trimming and installation on after market vehicles.

FIG. 8B is a view of the elevation of the driver side exterior rearview mirror which shows the position of the three sections of the mirror, along with the optional reddish tint, in Sections B and C along with a construction different from FIG. 2B and first surface reflective coating for installation on after market vehicle mirrors.

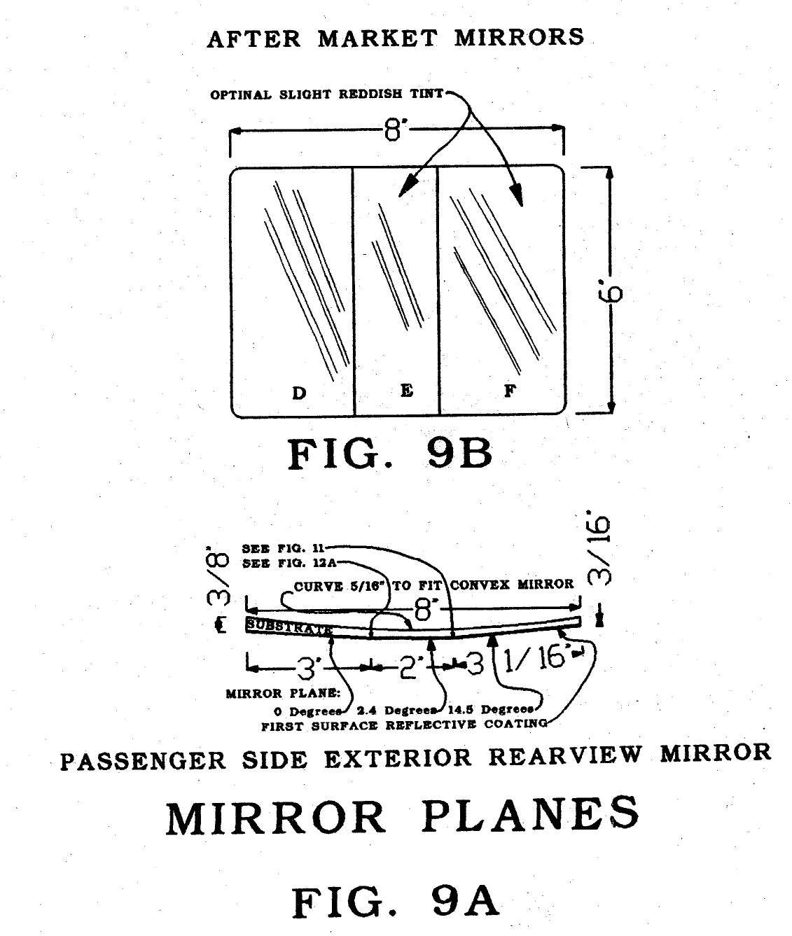

FIG. 9A is a view of the cutaway section of the passenger side exterior rearview mirror, which shows the angle and approximate width of each of the three sections of the mirror with the larger size for trimming and installation on after market vehicles.

FIG. 9B is a view of the elevation of the passenger side exterior rearview mirror which shows the position of the three sections of the mirror, along with the optional reddish tint, in Sections E and F along with a construction different from FIG. 3B and first surface reflective coating for installation on after market vehicle mirrors.

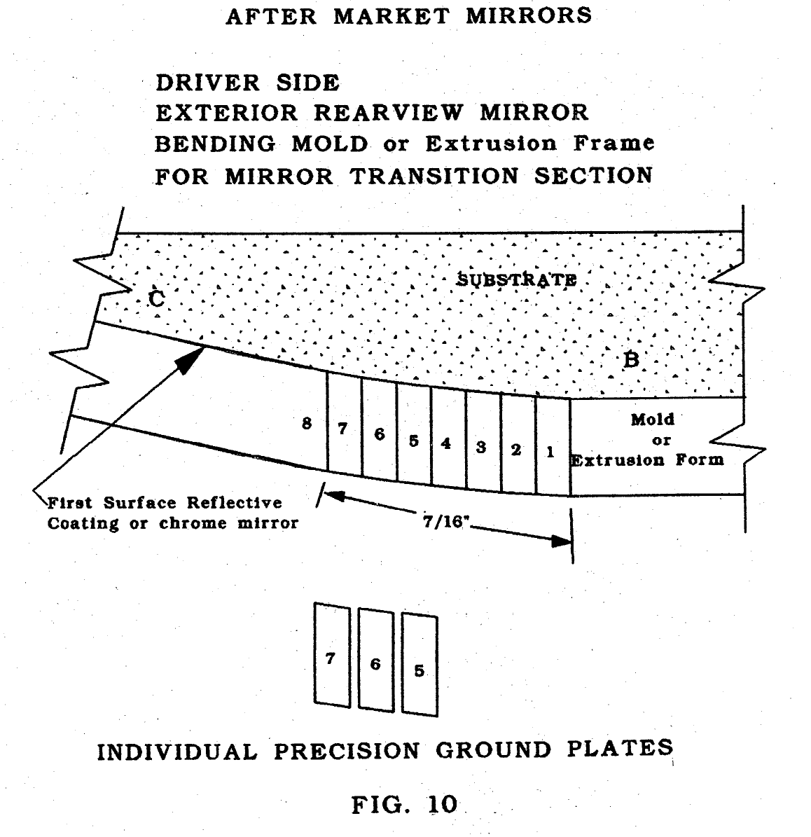

NOTE: Each transition plate detailed in FIGS. 10, 11, 12A, and 12B will be precision ground to exactly the degree needed to avoid noticeable view gaps, which should range from 1 degree down to ½ degree. The number of flat narrow plates will vary according to the degree or fractions thereof as needed to avoid noticeable view gaps.

FIG. 10, for the driver side exterior rearview mirror, is a detail of the transition flat plane bending plates that will be used in the mirror mold or extrusion frame to produce the narrow flat plane bending planes transition from mirror plane B to mirror plane C. The total transition is from approximately 2.2 degrees to approximately 10.5 degrees for the driver side exterior rearview mirror.

The span of the transition plates should remain approximately 7/32″.

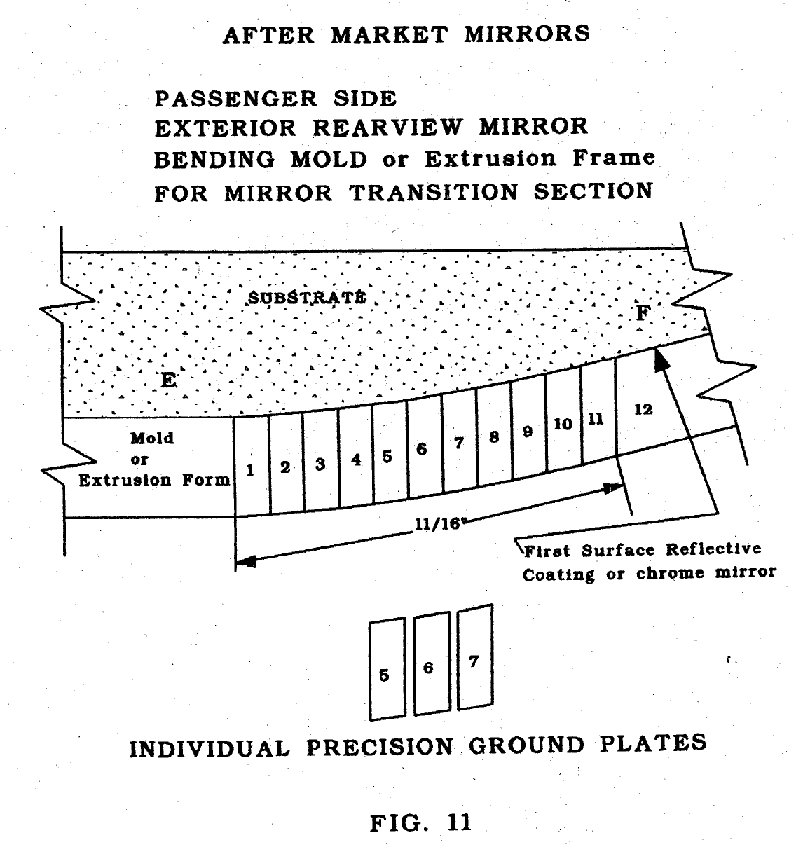

FIG. 11, for the passenger side exterior rearview mirror, is a detail of the transition flat plane bending plates that will be used in the mirror mold or extrusion frame to produce the narrow flat plane bending planes transition from mirror plane E to mirror plane F. The total transition is from approximately 2.4 degrees to approximately 14.5 degrees for the passenger side exterior rearview mirror. The span of the transition plates should remain approximately 5/16″.

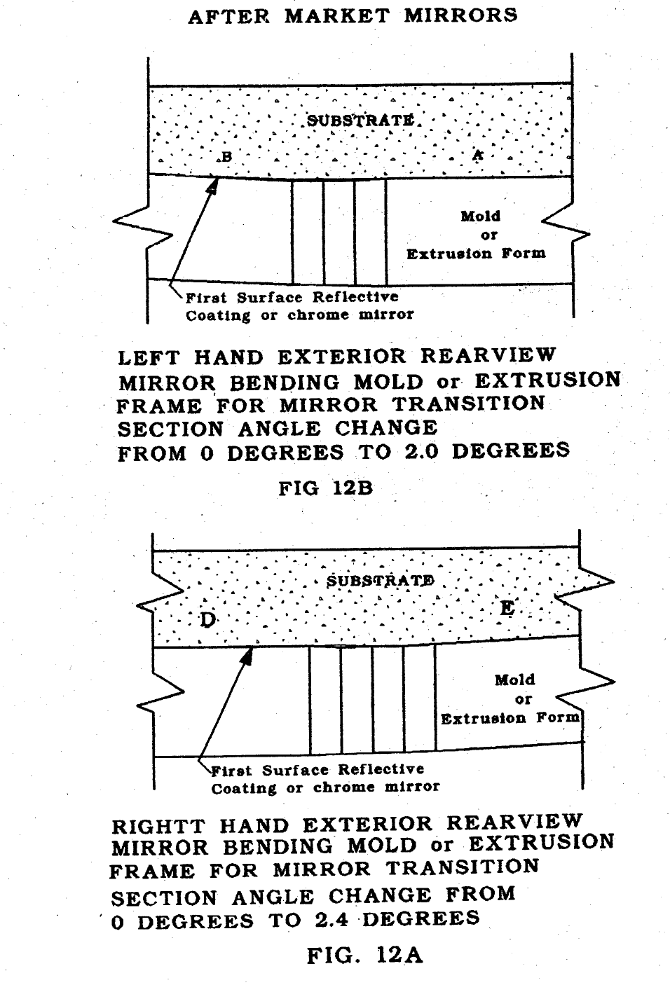

FIG. 12B, for the driver side exterior rearview mirror, is a detail of the transition bending plates that will be used in the glass mold to produce the narrow flat plane transition from mirror plane A to mirror plane B. The total transition is from 0 degrees to approximately 2.2 degrees for the driver side exterior rearview mirror. The span of the transition plates should remain approximately 3.75/32″.

FIG. 12A, for the passenger side exterior rearview mirror, is a detail of the transition bending plates that will be used in the glass mold to produce the narrow flat plane transition from mirror plane D to mirror plane E. The total transition is from 0 degrees to approximately 2.4 degrees for the passenger side exterior rearview mirror. The span of the transition plates should remain approximately ⅛″.

### DETAILED DESCRIPTION OF THE INVENTION

This invention is the shape and use of the exterior rearview mirrors only and does not include inventing any materials used in this invention. All of the materials that will be used in this invention have already been invented and are available for use in this invention.

A mold for each mirror will be prepared according to FIGS. 2A through 6B in which the glass for the mirrors will be heated to a liquid viscosity and poured into the mold which will shape the mirror glass exactly according to the details. The reflective material will be applied to the back of the mirror glass that has been shaped according to the details. The glass mirrors will be attached to the base and installed in the mounting containers similar to exterior rearview mirrors already being used.

For the After Market exterior rearview mirrors, a mold or extrusion frame for each mirror will be prepared according to FIGS. 8A through 12B in which the substrate base for the mirrors will be poured into the mold or processed through an extrusion frame which will shape the mirrors exactly according to the details. The First Surface reflective coating will be applied to the face of the substrate that has been shaped according to the details. The mirrors will be attached to the existing or OEM mirrors with an adhesive that has been designed to permanently bond to glass. The said mirrors will be produced larger than the existing or OEM mirrors, will be trimmed to an exact fit of the existing mirrors by the use of a paper template placed on the existing mirrors, and the exact perimeter of the existing mirrors traced on the template. The trimming will be done with a Coping saw blade attached to a band saw machine, jig saw, or a coping saw holder, then sanded, filed, and buffed to a fine finish, or optionally covered with a permanent edge tape.

This invention will provide a clear viable view of vehicles in the regular area, the overtaking area and the blind spot area without distortion. Vehicles in the overtaking area, B and E, will appear larger than vehicles in the regular area, A and D, and vehicles will appear much larger in the blind spot area, C and F.

Some prior exterior rearview mirror inventions used convex or concave mirrors that caused misleading distortion. Some used flat plane mirrors but used confusing positioning or disruptive dividers which caused confusion, etc., and did not provide a viable result. Virtually no effort was made to display vehicles in the overtaking area. The passenger side exterior rearview convex mirrors currently required on new autos by the U.S. Department of Transportation has increased the danger and has apparently created the “Road Rage” incidents as well as caused more accidents than the prior flat plane exterior rearview mirrors.

FIG. 1 shows how the mirrors will appear when mounted on vehicles. The drawing shows mounting containers which will be furnished by the existing mirrors manufacturer. With minor modifications the glass mirrors will fit into mounting containers already being manufactured by most companies that would manufacture this invention. The After Market mirrors will attach to the existing mirrors with a permanent weatherproof adhesive.

FIG. 2A and FIG. 3A detail the approximate width and angles for each mirror plane section. It shows how the glass mirror sections relate to each other and how each will be attached to the base. FIG. 8A and FIG. 9A details similar information for the After Market mirrors. The details show the angle for each mirror section, which is different for the driver side and the passenger side mirror. FIG. 2A and FIG. 8A provides details for the driver side_mirror. FIG. 3A and FIG. 9A provides details for the passenger side mirror. The substrate base will be a material that will not swell or shrink due to neither temperature changes nor moisture changes. The glass mirror will be attached to the substrate base with resilient adhesive to prevent breakage if the base should change size or shape. The After Market mirrors will be a first surface reflective coating applied to the substrate base. The glass in Sections B, C, E, and F may have an optional slight reddish tint.

FIG. 2B and FIG. 3B shows the height of the mirrors for automobiles and how the driver side exterior rearview mirror and passenger side exterior rearview mirror would look after they are mounted and secured in a container. FIG. 8B and FIG. 9B shows the oversized mirrors to allow for trimming to fit and be bonded to existing mirrors. All three glass mirror sections would be formed in a mold using the bending plates in FIGS. 4, 5, 6A, and 6B plus the details in FIGS. 2A, 2B, 3A, and 3B to form the shape of the mold. All three first surface reflective coated mirror substrate sections for After Market mirrors would be formed with a mold or extrusion frame as shown in FIGS. 10, 11, 12A, and 12B plus the details in FIGS. 8A, 8B, 9A, and 9B to form the shape of the mold.

FIGS. 4, 5, 6A, and 6B, shows the method which will shape the glass mirrors making a transition from one plane to the other with a series of narrow flat plane strip sections of the mirror instead of the basic method of three flat plane sections being molded together. The width and degree of change for each narrow strip section will be determined so that the view gap caused by the degree change will be so tiny that the naked eye will not notice the gap thus providing a natural view of each adjacent plane without distortion. The bent glass mirrors will then be attached to a stable substrate base. FIGS. 9A, 8B, 9A, and 9B shows the method which will shape the mirrors making a transition from one plane to the other for the After Market mirrors upon which the first surface coating will be applied to the substrate base. The glass in Sections B, C, E, and F may have a slight reddish tint including the narrow transition plane sections for the purpose of notifying the driver that any vehicles in either of these sections means “danger do not switch to their lane”. The increased size appearance and location in the mirror will be the absolute notification to the driver that the vehicles in B and C or E and F are in the danger zone so the drivers will not attempt a lane change.

FIG. 7A shows the viewing area, without the narrow flat transition bending planes sections, which will vary slightly for each driver due to the driver's distance from the mirror and the position of the driver's head crosswise the vehicle. Mirror Sections A and D will show vehicles hundreds of feet behind the driver's vehicle. Mirror Sections B and E will show the road and shoulder or a vehicle which is just behind the blind spot area and will show a vehicle that is overtaking the driver's vehicle which is about to enter the blind spot area. Mirror Sections C and F will show rapidly passing landscape until a vehicle moves into the blind spot area. The vehicle in the blind spot section will eliminate most if not all of the moving landscape and will make a dramatic change in the display in the C or F mirror section. The difference in the cross hatching shows the area displayed in the mirror with an optional slight reddish tint. It also shows how the exterior rearview mirrors will be positioned on the vehicles from front to rear of the vehicles.

FIG. 7B shows the same viewing area as FIG. 7A plus the small gaps are filled in with the series of very narrow flat plane sections so that when looking at the mirror, the image will appear as one continuous image without any noticeable gaps nor distortion. The difference in the cross-hatching shows the area displayed in the mirror that may have a reddish tint.

The height of the auto mirrors will be approximately four and one half inches (4½″), except that some vehicle mirrors may be as high as approximately 16″. Mirror sections A and D will be approximately three inches wide (3″). Mirror sections B and E will be approximately two inches wide (2″). Mirror sections C and F will be approximately three inches wide (3″). All sections may be made wider or taller if regulation modifications permit. All sections will be made completely of a flat plane mirror surface without any curves. The substrate base will be made with non-swelling and non-shrinking material with three different planes with the angles as shown on FIG. 2A and FIG. 3A and FIG. 8A and FIG. 9A. It must be noted that the passenger side mirror will have different viewing angles from the driver side mirror. The glass mirrors will be attached to the base with waterproof resilient adhesive to avoid the possibility of cracking the mirrors in extreme weather conditions. The After Market first surface coating mirrors, will also contain a clear protective coating and, will be applied to the substrate, which will then be bonded to the mirrors already attached to the vehicles.

The housing containers, which will fasten the glass mirror assembly to the vehicles, will be the same units now being used or produced by the manufacturer with minor adjustments.

1. A. An exterior rearview one-piece molded or extruded mirror assembly for motor vehicles, and nonmotorized vehicles, comprising; a driver side exterior rearview mirror and a passenger side exterior rearview mirror mounted on the front portion of said vehicles on or with a support member;
said exterior rearview mirrors consisting of three flat plane sections with varying widths to accommodate different type and width vehicles connected by narrow flat plane transition strips with each strip varying widths and degrees approximating 1/32 to 1/16 width and ½ to 1 degree per strip to provide an image gap so small as to be unnoticed by the naked eye and to provide without distortion a view of the regular area, overtaking area, and the blind spot but not limited to the following details which are approximated for standard size automobiles:
said driver side exterior rearview mirror consisting of first, second, and third flat plane reflective sections for displaying regular rearview area, over taking area, and blind spot area respectively, said section positioned nearest to driver of the vehicle with 0 degree inclination, said second section positioned between the first and third section with approximately 2.2 degree inclination with respect to the first section, and said third section positioned furthermost to the driver of the vehicle with approximately 10.5 degree inclination;
said passenger side exterior rearview mirror consisting of first, second, and third flat plane reflective sections for displaying regular rearview area, over taking area, and blind spot area respectively, said first section positioned nearest to the driver of the vehicle with 0 degree inclination, said second section positioned between the first and third section with approximately 2.4 degree inclination with respect to the first section, and said third section positioned furthermost to driver of the vehicle with approximately 14.5 degree inclination;
a first narrow flat plane reflective transition section positioned between said first and second flat plane sections, said first transition section graduating from one of said flat plane section to the next flat plane section with a degree change by ½ degree to 1 degree for each multiple narrow flat plane transition strip until the next said regular flat plane section, a second narrow reflective transition section positioned between said second and third flat plane sections, said second transition section graduating from one of said flat plane section to the next flat plane section with a degree change of ½ degree to 1 degree for each multiple narrow flat plane transition strip until the next said flat plane section, use of ½ degree change will double the number of narrow flat plane strips, shown on the details, as needed to reach the next flat plane section;
wherein said multiple narrow flat plane transition strips provide almost invisible vision gaps between said wide flat plane sections in said exterior rearview mirrors;
the cited degree inclinations are for standard automobiles built in the year 2000, the degree inclinations will vary for both driver and passenger side depending on the location where attached to the vehicle along with minor manufacturing adjustments, and the said passenger side degree inclinations will vary due to the location and width of the vehicles for which said exterior rearview mirrors are built, varying from a motorcycle, or bicycle, up to any width of any vehicle or object moving on a highway, road, or street;
the height and width of said side rearview mirror sections will vary as needed for different type vehicles and as determined by the governing authorities having jurisdiction;
these same triple flat plane sections connected with multiple narrow flat plat plane transition strips will also perform in the same manner for a vertical view as may be needed for a closer view adjacent to the driver's vehicle;
B. Mirrors with the same viewing angles and shape for After Market Vehicles will be made, by mold or extrusion, with a substrate base and a first surface reflective coating material, plus clear protective coating, applied to the substrate base, that can be trimmed and finished by the installer to fit the existing mirrors, oversized for trimming purposes with a width of 8 inches, or slightly wider than road regulations, height of at least 6 inches, plus extra height for taller mirrors passenger side, with a substrate base curve to fit the current convex mirrors, or flat for older non convex mirrors, and be bonded to the existing mirrors with waterproof adhesive designed to permanently bond to glass, which is currently available from other sources, optionally pre-coated on the substrate base and temporarily covered.
